(19) United States
(12) Patent Application Publication
(10) Pub. No.: US 2014/0136582 A1
(43) Pub. Date: May 15, 2014

(54) METHOD AND APPARATUS FOR DIGITAL AUTOMATIC GAIN CONTROL

(71) Applicant: FUTUREWEI TECHNOLOGIES, INC., Dallas, TX (US)

(72) Inventors: Weizhong Chen, Austin, TX (US); Yuanpei Jiao, Shanghai (CN); Tong Sun, Frisco, TX (US)

(73) Assignee: Futurewei Technologies, Inc., Dallas, TX (US)

(21) Appl. No.: 13/674,698

(22) Filed: Nov. 12, 2012

(51) Int. Cl. G06F 7/02

(52) U.S. Cl. CPC G06F 7/026
USPC 708/207

(57) ABSTRACT

A method for scaling a plurality of data values includes storing a first subset of data values of the plurality of data values into a first vector register, determining a maximum data value of the first subset of data values, and storing the greater of the maximum data value and a value stored in a scalar register to the scalar register. Each data value of the subset of data values is stored in a different element of the first vector register. The method further includes determining an adjustment factor based on the value stored in the scalar register and adjusting each data value of the plurality of data values by the adjustment factor.

### BACKGROUND

1. Field

The subject matter disclosed herein relates generally to telecommunications devices, and more particularly to a method and apparatus for performing digital automatic gain control.

2. Description of Related Art

Digital automatic gain control (DAGC) is required in many parts of a baseband processing system of various telecommunications devices. DAGC is required when overflow/underflow control is required. For example, overflow and underflow control is typically required for fixed-point digital signal processing. However, even for a floating-point digital signal processor (DSP) that performs signal-processing operations, DAGC is also needed because the dynamic range of the floating-point DSP is also limited for power-reduction purposes.

DAGC is also required for scaling data prior to processing by subsequent hardware accelerator (HAC). The HAC may be designed to process data in both fixed-point and floating point. In either case, to reduce hardware complexity of the HAC, the HAC requires the input data to be scaled within a desired range before processing.

Performing DAGC on data values represented in fixed point requires maximum magnitude searching of fixed-point data values. Hardware implementation to perform such DAGC is relatively costly.

### BRIEF DESCRIPTION

In a first aspect, a method for scaling a plurality of data values includes storing a first subset of data values of the plurality of data values into a first vector register, determining a maximum data value of the first subset of data values, and storing the greater of the maximum data value and a value stored in a scalar register to the scalar register. Each data value of the subset of data values is stored in a different element of the first vector register. The method further includes determining an adjustment factor based on the value stored in the scalar register, and adjusting each data value of the plurality of data values by the adjustment factor.

In a second aspect, a method for scaling a plurality of data values includes initializing a first vector register with a first subset of data values of the plurality of data values. Each data value of the subset of data values is stored in a different element of the first vector register. The method further includes storing a second subset of data values of the plurality of data values into a second vector register, comparing the data value of each element of the first vector register with the data value for the corresponding element of the second vector register to determine which data value is greater, and storing the greater data value to the corresponding element of the first vector register. The method further includes determining a maximum data value of the data values stored in the first vector register, determining an adjustment factor based on the determined maximum data value, and adjusting each data value of the plurality of data values by the adjustment factor.

In a third aspect, an apparatus for scaling a plurality of data values includes a processor configured to execute instructions and a vector processor that includes hardware configured to implement at least some of the instructions executed by the processor. The processor is configured to store a first subset of data values of the plurality of data values into a first vector register, issue an instruction to the vector processor that causes the vector processor to return a maximum data value of the first subset of data values, and store the greater of the maximum data value and a value stored in a scalar register to the scalar register. The processor is further configured to determine an adjustment factor based on the value stored in the scalar register, and adjust each data value of the plurality of data values by the adjustment factor.

In a second aspect, an apparatus for scaling a plurality of data values includes a processor configured to execute instructions and a vector processor that includes hardware configured to implement at least some of the instructions executed by the processor. The processor is configured to initialize a first vector register with a first subset of data values of the plurality of data values. Each data value of the subset of data values is stored in a different element of the first vector register. The processor is further configured to store a second subset of data values of the plurality of data values into a second vector register, issue a first instruction to the vector processor that causes the vector processor to compare the data value of each element of the first vector register with the data value for the corresponding element of the second vector register to determine which data value is greater, and store the greater data value to the corresponding element of the first vector register. The processor is further configured to issue a second instruction to the vector processor that causes the vector processor to return a maximum data value of the data values stored in the first vector register, determine an adjustment factor based on the determined maximum data value, and adjust each data value of the plurality of data values by the adjustment factor.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims.

FIG. 1 is an exemplary schematic of a baseband processor portion of a telecommunications device;

FIG. 2 illustrates exemplary operations for adjusting the gain of data values;

FIG. 3 illustrates exemplary operations for determining the maximum exponent of the data values in a first embodiment;

FIG. 4 illustrates an exemplary hardware-implemented vector-register instruction for determining the maximum value of data values stored in a vector register;

FIG. 5 illustrates exemplary operations for determining the maximum exponent of the data values in a second embodiment;

FIG. 6 illustrates an exemplary hardware-implemented vector-register instruction for comparing corresponding elements of first and second vector registers;

FIG. 7 illustrates an exemplary hardware-implemented vector-register instruction for scaling data values of a vector register; and

FIG. 8 illustrates exemplary operations for scaling the data values that may be performed by hardware that implements the vector-register instruction of FIG. 7.

### DETAILED DESCRIPTION

The embodiments below overcome the issues discussed above in performing DAGC by providing specialized vector-processing hardware that facilitates fast determination of the maximum data value in a set of data values. Generally, the maximum data value is determined by comparing the exponent of the respective data values to identify the maximum data value. An adjustment factor is then determined based on the maximum exponent, and the exponents of the data values are adjusted by the adjustment factor. The vector processor includes hardware that facilitates determining the maximum data value within a vector register, which facilitates fast determination of the maximum data value. The vector processor also includes hardware configured to scale data values in a vector register by the same amount.

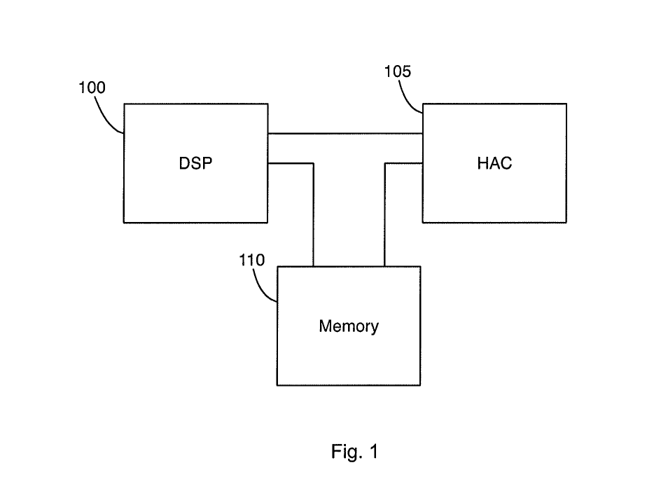

FIG. 1 is an exemplary schematic of a baseband processor portion of a telecommunications device. Shown are a digital-signal-processor (DSP) 100, a memory 110, and a hardware accelerator (HAC) 105. The DSP 100 may correspond to any processor that is optimized for performing high-speed computational analysis that is typically required when digitally processing signals. For example, the DSP 100 may be configured to perform computations in both fixed point and floating point. The DSP 100 may include additional hardware, such as timers, interrupt controllers, memory interfaces, etc., that facilitate processing baseband signals of a telecommunications device, such as a mobile phone. The DSP 100 may execute instruction code for processing the baseband signals. For example, the DSP 100 may execute code that operates in conjunction with the HAC 105 to adjust the gain of a signal for further processing by the HAC 105. The DSP 100 may also include hardware that implements various vector-processing op codes (i.e., instructions) for performing an operation on blocks of data with a single op code.

Signals processed by the DSP are represented as a sequence of binary data values stored in the memory 110. One form of digital processing that may be performed is scaling or amplitude adjustment of the signal. That is, the magnitude of the data values are scaled up or down until the magnitude of the data values match the dynamic range requirements of the DSP 100 and/or HAC 105. In one embodiment, the data values are real numbers represented in a floating-point representation of the form:

mantissa×base^{exponent}

The mantissa and exponent are represented by a fixed number of bits. For example, eight bits for the mantissa and eight bits for the exponent. The base is chosen ahead of time and may be 2, 10, 16, etc. In one implementation, the DSP 100 scales the data values up or down by adjusting the exponent for each data value.

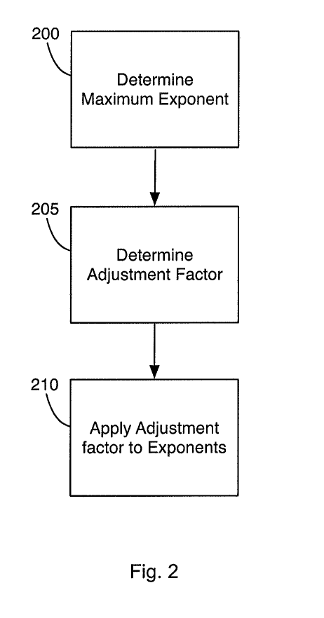

FIG. 2 illustrates exemplary operations for adjusting the gain of the data values. The operations may be performed by the DSP 100, the HAC 105 or a combination of the two. In this regard, instructions for causing the DSP 100 to perform some or all of the operations may be stored in one or more non-transitory types of computer readable media.

At block 200, data values associated with a signal are analyzed to identify the maximum exponent of all the data values. The data value with the largest exponent generally corresponds to the data value with the largest magnitude or is one of the data values with the largest magnitude, although it is understood that the magnitude also depends to a degree on the significant digits (i.e., the mantissa) of the data value.

At block 205, an adjustment factor is determined for scaling the data values of the signal. The adjustment factor is a value that, when applied to the data values of the signal, scales the data values to better match the requirements of the DSP 100 and/or HAC 105. For example, if the largest data value of the signal is only fifty percent of the maximum data value that may be processed by the HAC 105, an adjustment factor of two may be appropriate.

At block 210, the data values of the signal may be adjusted by the adjustment factor. That is, the exponent of the data values may be scaled by the adjustment factor. The data values may be scaled and stored again to the memory 110. Alternatively, the adjustment factor may be communicated to the HAC 105, which may include hardware for scaling the exponent of the data values by the adjustment factor.

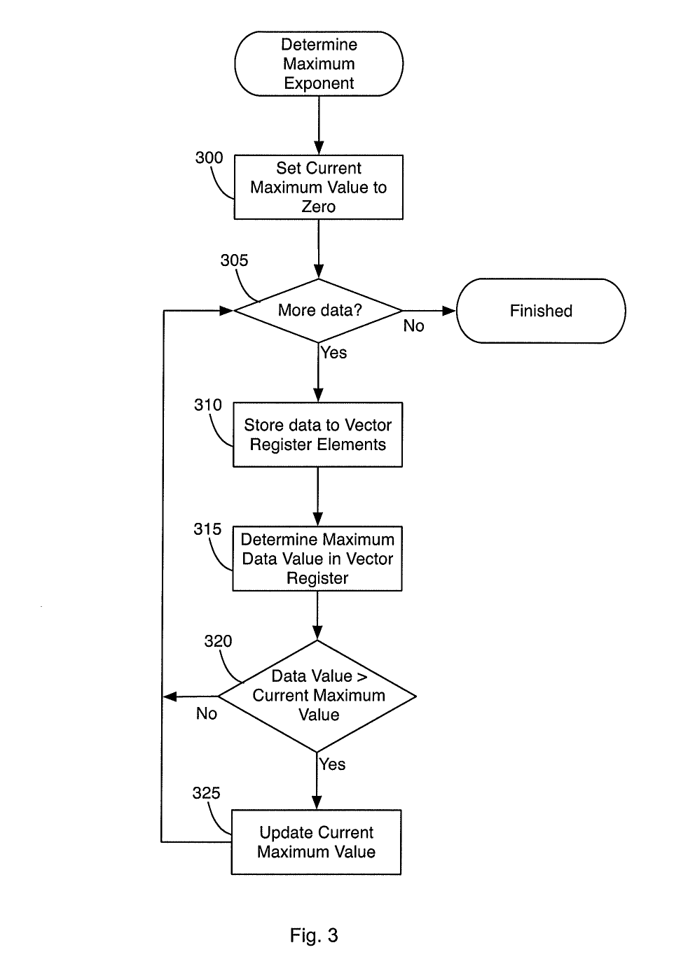

FIG. 3 illustrates exemplary operations for determining the maximum exponent of the data values associated with a signal in a first embodiment. The operations in FIG. 3 may be performed at block 200 described above. The operations may be implemented in the DSP 100. In this regard, the DSP may execute instruction code that causes the DSP to perform the various operations. To facilitate fast and efficient execution of the code, some of the instructions may be single-instruction-multiple-data (SIMD) types of instructions that utilize vector-processing hardware of the DSP 100 that is optimized to perform the same operation on a vector of data values. That is, a single SIMD op code of the DSP may facilitate performing the same operation on a number of data values. For example, a single SIMD ADD op code may be utilized to add the same number to eight data values simultaneously. The size of the vector, and thus the number of simultaneous operations, may vary. In one implementation, 8-way SIMD is utilized. That is, the SIMD instructions are configured to perform an operation on a vector of size eight (i.e., eight data values). It is understood that 16-way, 32-way, etc., SIMD may be utilized to perform the operations disclosed herein more efficiently at the cost of increased hardware complexity.

At block 300, a scalar register of the DSP 100 (i.e., a non-vector register) is initialized, for example, to a value of zero. At block 305, if there are non-evaluated data values, then at block 310 a vector of data values is retrieved from the memory 110 and stored in a vector register of the DSP. For example, eight data values may be loaded in the vector register. Each data value is stored as one element of the vector register.

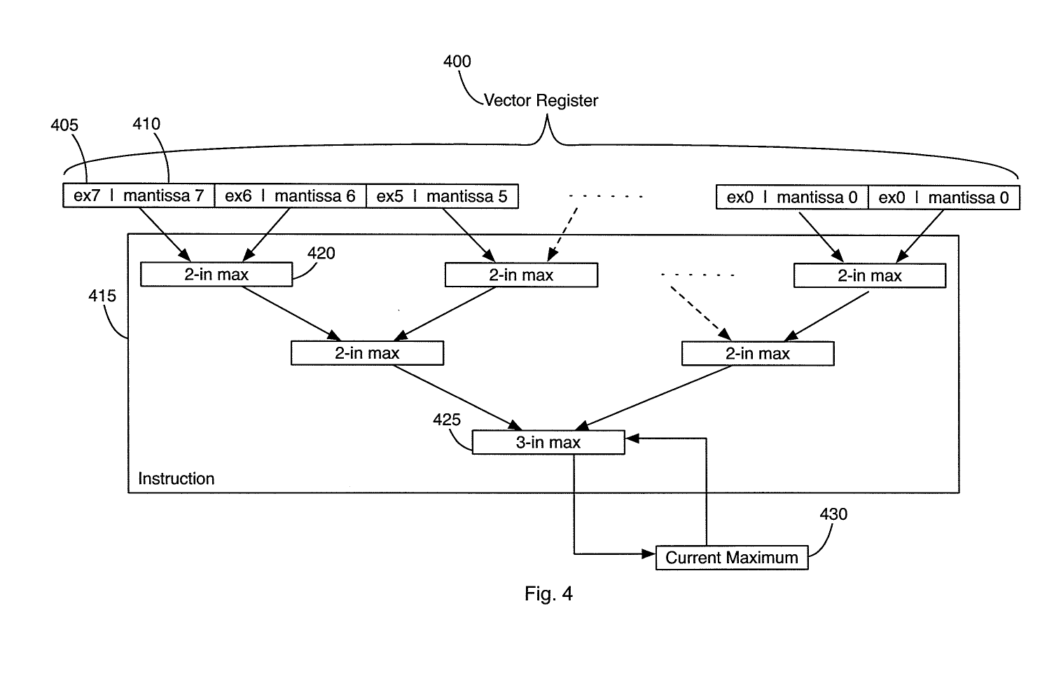

At block 315, the maximum data value within the vector register is determined. FIG. 4 illustrates one implementation for determining the maximum data value in the vector register.

FIG. 4 illustrates an exemplary hardware-implemented vector-register instruction 415 for determining the maximum value of data values stored in a vector register 400. In this case, the vector-register 400 stores eight data values. Each element of the vector-register 400 stores a data value that is represented in floating-point with an exponent 405 and mantissa 410. An SIMD instruction 415, such as a MAX instruction of the DSP, is utilized to determine the data value with the largest exponent 405. Hardware that implements the MAX instruction may, through a hierarchy of modules, compare the exponents of data values stored in elements of the vector-register 400 until the maximum data value is determined. In some implementations, the mantissa of the respective data values is also compared. For example, the hardware may include a group of 2-in max modules 420 configured to output the maximum value of two input values. Four 2-in max modules 420 may be utilized to compare pairs of elements of the vector-register 400, which reduces the number of data values left to evaluate to four. Similarly, two 2-in max modules 420 may compare the four data values, which reduces the number of data values left to evaluate to two. A 3-in max module 425 compares the two data values with the current maximum exponent value stored in the scalar register 430, which results in a value that is the maximum data value of the three.

Returning to FIG. 3, at block 320, if the result from the last comparison is greater than the value stored in the current maximum scalar register, then at block 325, the scalar register is updated with the new maximum exponent value. Otherwise, the operations repeat from block 305 until all the data values have been analyzed.

As shown, the operations facilitate faster determination of the maximum value of the data by processing the data utilizing vector instructions that facilitate fast determination of a maximum value within a vector register. Of course, it is understood that speed may be improved by utilizing larger vector registers. That is, vector registers that store more than eight elements. Moreover, different instructions for comparing the individual elements to one another may be utilized as well. For example, while FIG. 4 illustrates comparison of two elements at a time via 2-in max modules 420, it is understood that the hardware could be configured to compare three or more elements at a time.

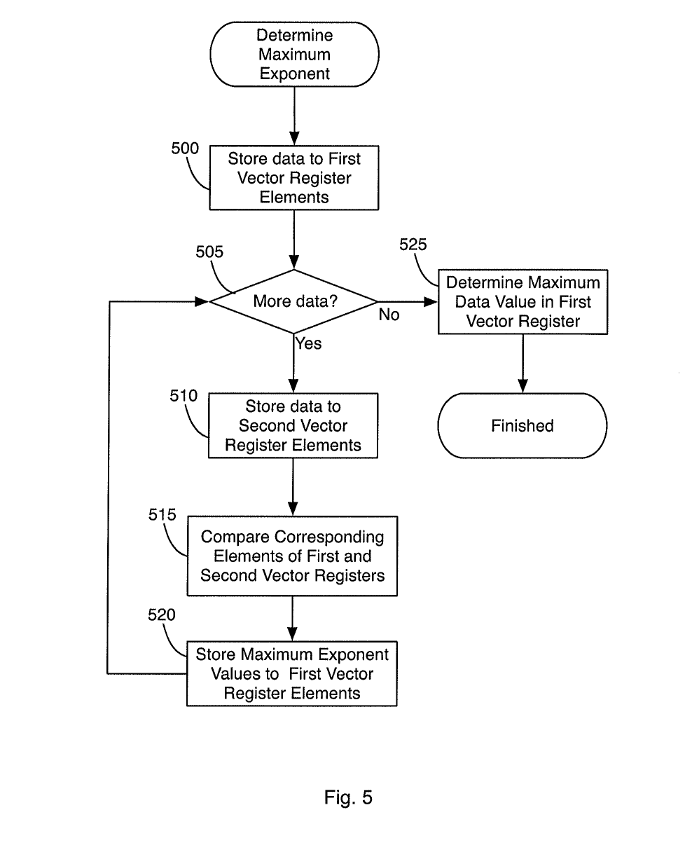

FIG. 5 illustrates exemplary operations for determining the maximum exponent of the data values associated with a signal, in second embodiment. The operations in FIG. 3 may be performed at block 200 described above. At block 500, a group of data values are stored to a first vector register. For example, eight data values may be retrieved from memory 110 and stored to eight elements, respectively, of the first vector register.

At block 505, if the are additional data values in the memory 110 to evaluate, then at block 510, a next group of data values are stored to a second vector register.

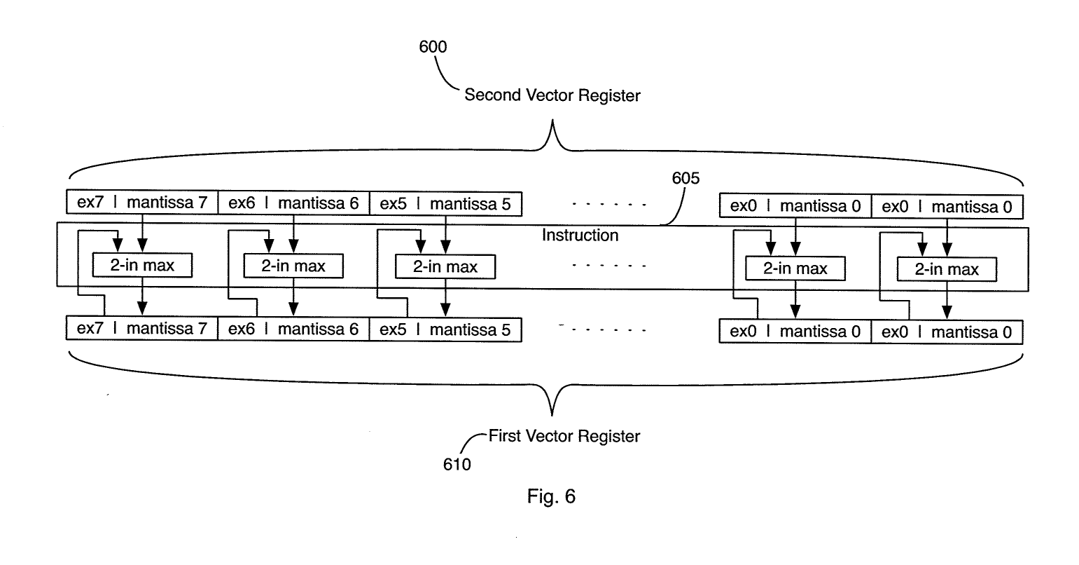

At block 515, the data values in the elements of the first vector register are compared with the data values in the corresponding elements of the second vector register to determine the maximum value for each comparison, as illustrated in FIG. 6.

FIG. 6 illustrates an exemplary hardware-implemented vector-register instruction 605 for comparing corresponding elements of first and second vector registers (610, 600). As shown, the hardware may include a group of 2-in max modules, one for each element of the respective vector registers (600, 610). The 2-in max modules are configured to output a maximum of two input values by comparing the exponents of the data values of the elements being compared. In some implementations, the mantissa of the respective data values is also compared.

Returning to FIG. 5, at block 520, the resulting maximum values are stored back to the first vector register. The operations then repeat from block 505.

If at block 505, there are more data values to evaluate, then the next group of data values are loaded into the second vector register and compared with the data values stored in the first vector register.

If at block 505, there are no more data values to evaluate, the maximum data value stored in the first vector register is determined. The maximum data value may, for example, be determined in a manner similar to the operations associated with FIG. 4 described above. For example a hierarchy of 2-in max modules may be utilized to determine the maximum value stored in the vector register as described above.

As noted above with reference to FIG. 2, at block 205, an adjustment factor may be determined based on the determined maximum exponent. For example, if the magnitude of the largest data value is only 50% of the maximum signal that may be processed by the DSP 100 and/or the HAC 105, an adjustment factor of two may be determined.

At block 210, the adjustment factor is applied to the exponents of all the data values. For example, the DSP 100 may scale the exponents of all the data values in the memory by the adjustment factor. Alternatively, the adjustment factor may be communicated to the HAC 105, and the HAC 105 may scale the data values prior to further processing.

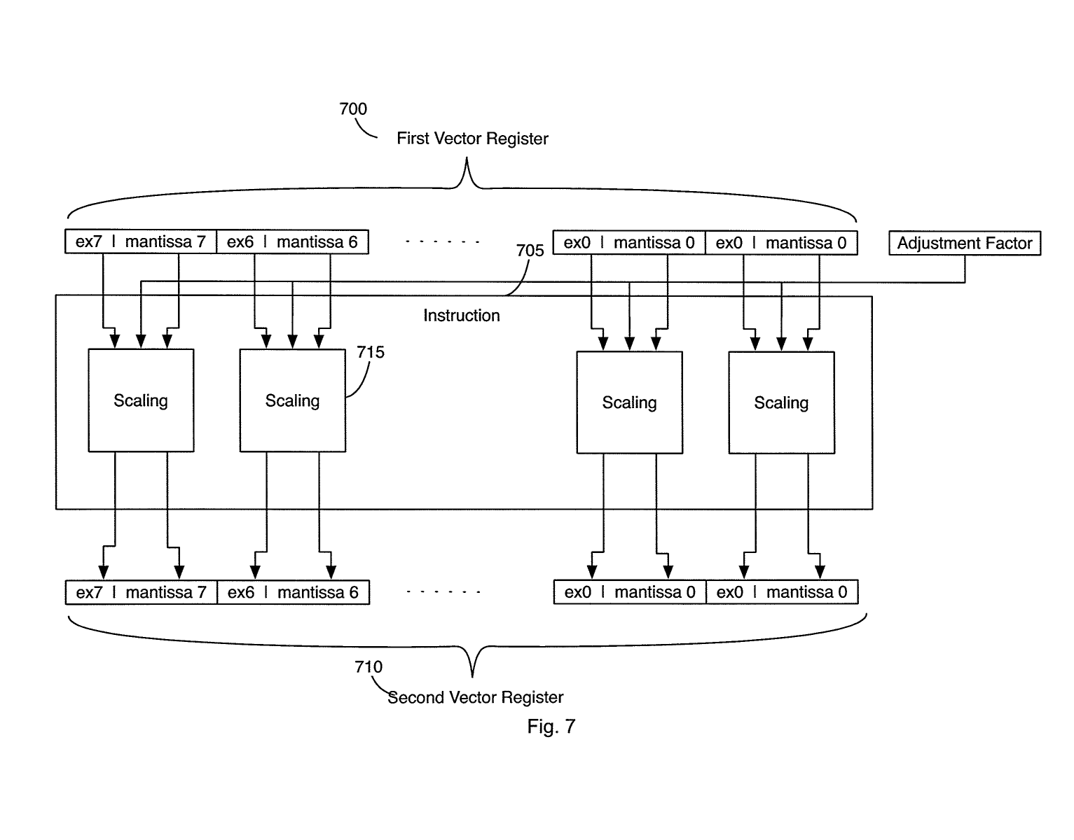

FIG. 7 illustrates exemplary hardware logic 705 associated with a vector-register instruction for scaling data values of a vector register. The hardware logic 705 scales the data value of each element of a first vector register 705 and stores the result in a second vector register 710. In alternative implementation, the scaled result may be stored back to the first vector register 700. The hardware logic 705 may include a group of scaling modules 715, one for each element in the vector. The scaling modules 715 are configured to compute a scaled version of a data value based on the original data value and an adjustment factor.

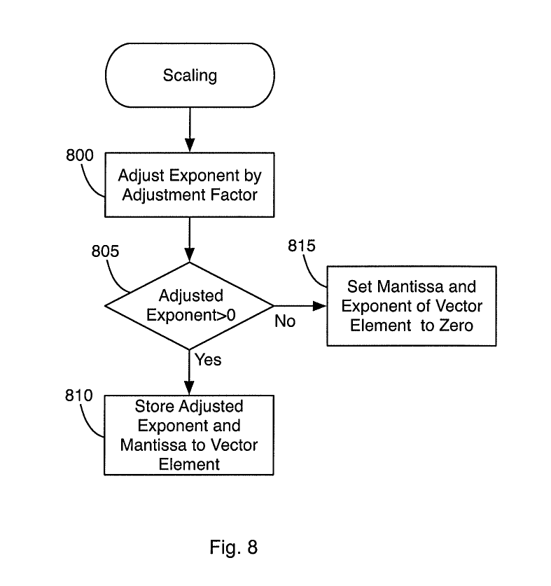

FIG. 8 illustrates a group of operations that may be performed by the scaling modules 715. At block 800, each scaling module 715 may adjust the exponent of a data value.

At block 805, if the adjusted exponent is greater than zero, then at block 810, the adjusted exponent and the mantissa of the original data value are output from the scaling modules 715.

If at block 805, the adjusted exponent is zero or less, then at block 815, the value zero is written to both the mantissa and exponent portions of the data value. This prevents the data values from being adjusted below zero, which could prevent further processing of the data values by the DSP and/or the HAC.

Thus, the operations above enable fast scaling of the data values by an adjustment factor. This, in conjunction with fast determination of the maximum data value, facilitates fast and efficient DAGC.

While various embodiments of the embodiments have been described, it will be apparent to those of ordinary skill in the art that many more embodiments and implementations are possible that are within the scope of the claims. Accordingly, it will be apparent to those of ordinary skill in the art that many more embodiments and implementations are possible that are within the scope of the claims. Therefore, the embodiments described are only provided to aid in understanding the claims and do not limit the scope of the claims.

What is claimed is:

1. A method for scaling a plurality of data values comprising:
storing a first subset of data values of the plurality of data values into a first vector register, wherein each data value of the subset of data values is stored in a different element of the first vector register;
determining a maximum data value of the first subset of data values;
storing the greater of the maximum data value and a value stored in a scalar register to the scalar register;
determining an adjustment factor based on the value stored in the scalar register; and
adjusting each data value of the plurality of data values by the adjustment factor.

2. The method according to claim 1, wherein each data value of the plurality of data values is a floating point binary representation of a number.

3. The method according to claim 2, wherein determining the maximum data value comprises determining a maximum exponent of the first subset of data values.

4. The method according to claim 3, wherein adjusting each data value of the plurality of data values comprises adjusting an exponent of each data value by the adjustment factor.

5. The method according to claim 4, wherein adjusting each data value of the plurality of data values comprises determining whether an adjusted data value is below a threshold; and
if the adjusted data value is below the threshold, setting the adjusted value to the threshold.

6. The method according to claim 3, wherein determining the maximum data value of the first subset of data values further comprises:
comparing data values stored in different pairs of elements of the first vector register to determine a first set of maximum values of the respective pairs; and
iteratively comparing pairs of the first set of maximum values to determine subsequent sets of maximum values until all the values have been compared.

7. The method according to claim 1, wherein storing of the first subset of data values of the plurality of data values into a first vector register; determining of the maximum data value of the first subset of data values; and storing of the greater of the maximum data value and the value stored in a scalar register to the scalar register occur repetitively and until all data values of the plurality of data values have been evaluated.

8. A method for scaling a plurality of data values comprising:
initializing a first vector register with a first subset of data values of the plurality of data values, wherein each data value of the subset of data values is stored in a different element of the first vector register;
storing a second subset of data values of the plurality of data values into a second vector register, wherein each data value of the second subset of data values is stored in a different element of the second vector register;
comparing the data value of each element of the first vector register with the data value for the corresponding element of the second vector register to determine which data value is greater; and
storing the greater data value to the corresponding element of the first vector register;
after all the data values of the plurality of data values have been evaluated, determining a maximum data value of the data values stored in the first vector register;
determining an adjustment factor based on the determined maximum data value; and
adjusting each data value of the plurality of data values by the adjustment factor.

9. The method according to claim 8, wherein each data value of the plurality of data values is a floating point binary representation of a number.

10. The method according to claim 9, wherein determining the maximum data value comprises determining a maximum exponent of the first subset of data values.

11. The method according to claim 10, wherein adjusting each data value of the plurality of data values comprises adjusting an exponent of each data value by the adjustment factor.

12. The method according to claim 11, wherein adjusting each data value of the plurality of data values comprises determining whether an adjusted data value is below a threshold; and
if the adjusted data value is below the threshold, setting the adjusted value to the threshold.

13. The method according to claim 10, wherein determining the maximum data value of the first subset of data values further comprises:
comparing data values stored in different pairs of elements of the first vector register to determine a first set of maximum values of the respective pairs; and
iteratively comparing pairs of the first set of maximum values to determine subsequent sets of maximum values until all the values have been compared.

14. The method according to claim 8, wherein storing of the second subset of data values of the plurality of data values into the second vector register; comparing of the data value of each element of the first vector register with the data value for the corresponding element of the second vector register to determine which data value is greater; and storing of the greater data value to the corresponding element of the first vector register occur repetitively and until all data values of the plurality of data values have been evaluated.

15. An apparatus for scaling a plurality of data values comprising:
a processor configured to execute instructions; and
a vector processor that includes hardware configured to implement at least some of the instructions executed by the processor,
wherein the processor is configured to repetitively and until all data values of the plurality of data values have been evaluated:
store a first subset of data values of the plurality of data values into a first vector register, wherein each data value of the subset of data values is stored in a different element of the first vector register, and
issue an instruction to the vector processor that causes the vector processor to return a maximum data value of the first subset of data values;
wherein the processor is further configured to store the greater of the maximum data value and a value stored in a scalar register to the scalar register, and, determine an adjustment factor based on the value stored in the scalar register, and adjust each data value of the plurality of data values by the adjustment factor.

16. The apparatus according to claim 15, wherein each data value of the plurality of data values is a floating point binary representation of a number.

17. The apparatus according to claim 16, wherein the vector processor is configured to determine the maximum data value by determining a maximum exponent of the first subset of data values.

18. The apparatus according to claim 17, wherein the processor is configured to adjust each data value of the plurality of data values by adjusting an exponent of each data value by the adjustment factor.

19. The apparatus according to claim 15, wherein the processor is configured to repetitively and until all data values of the plurality of data values have been evaluated:
store the first subset of data values of the plurality of data values into the first vector register, and
issue the instruction to the vector processor that causes the vector processor to return the maximum data value of the first subset of data values.

20. An apparatus for scaling a plurality of data values comprising:
a processor configured to execute instructions; and
a vector processor that includes hardware configured to implement at least some of the instructions executed by the processor,
wherein the processor is configured to initialize a first vector register with a first subset of data values of the plurality of data values, wherein each data value of the subset of data values is stored in a different element of the first vector register;
wherein the processor is further configured to:
store a second subset of data values of the plurality of data values into a second vector register, wherein each data value of the second subset of data values is stored in a different element of the second vector register;
issue a first instruction to the vector processor that causes the vector processor to compare the data value of each element of the first vector register with the data value for the corresponding element of the second vector register to determine which data value is greater, and store the greater data value to the corresponding element of the first vector register;
wherein, the processor is further configured to:
issue a second instruction to the vector processor that causes the vector processor to return a maximum data value of the data values stored in the first vector register;
determine an adjustment factor based on the determined maximum data value; and
adjust each data value of the plurality of data values by the adjustment factor.

21. The apparatus according to claim 20, wherein each data value of the plurality of data values is a floating point binary representation of a number.

22. The apparatus according to claim 21, wherein the vector processor is configured to determine the maximum data value by determining a maximum exponent of the first subset of data values.

23. The apparatus according to claim 22, wherein the processor is configured to adjust each data value of the plurality of data values by adjusting an exponent of each data value by the adjustment factor.

24. The apparatus according to claim 20, wherein the processor is configured to repetitively and until all data values of the plurality of data values have been evaluated:
store the second subset of data values of the plurality of data values into the second vector register, wherein each data value of the second subset of data values is stored in the different element of the second vector register;
issue the first instruction to the vector processor that causes the vector processor to compare the data value of each element of the first vector register with the data value for the corresponding element of the second vector register to determine which data value is greater, and store the greater data value to the corresponding element of the first vector register.
